(19) United States
(12) Patent Application Publication
(10) Pub. No.: US 2011/0204101 A1
(43) Pub. Date: Aug. 25, 2011

(54) NOZZLE ASSEMBLY

(75) Inventor: Jon Jenkins, Wooster, OH (US)

(73) Assignee: AKRON BRASS COMPANY, Wooster, OH (US)

(21) Appl. No.: 13/033,244

(22) Filed: Feb. 23, 2011

Related U.S. Application Data
(60) Provisional application No. 61/307,067, filed on Feb. 23, 2010.

(51) Int. Cl. B05B 1/00

(52) U.S. Cl. 222/566

(57) ABSTRACT

A nozzle assembly has a generally hollow shutoff body comprising a unitary member. The shutoff body further includes an inlet portion, an outlet portion, a shutoff body portion, a nozzle body adapter portion, and a nozzle body portion.

This application claims priority to U.S. provisional patent application No. 61/307,067, filed Feb. 23, 2010, the contents of which are hereby incorporated by reference.

### FIELD

This invention relates to nozzles, more particularly to nozzles of the fire fighting type.

### BACKGROUND

Conventionally, a nozzle is connected to an end portion of a fire hose and is used to direct fluids discharged from the hose. The nozzle is sometimes provided with an on/off mechanism for selectably controlling the discharge of fluids from the nozzle. Some nozzles also provide means for varying the flow rate of the fluids and/or the pattern in which fluids are discharged.

Many nozzles that are used in conjunction with firefighting apparatus are highly sophisticated pieces of equipment, containing a number of complex interconnected components. The more components involved, the more labor is required to produce the nozzles, adding to the expense. Consequently, many cost-constrained firefighting organizations have fewer nozzles in their inventory than is desirable. This is particularly true for developing nations where funds to purchase firefighting equipment are limited.

### SUMMARY

A nozzle assembly is disclosed according to several embodiments of the present invention. The nozzle assembly is made from fewer components than current nozzles. Previously separate components are consolidated together and made as a unit, reducing overall component cost. A reduced parts count also reduces the amount of labor required to assemble and repair the nozzles. The combination of reduced material cost and reduced labor results in a nozzle having a lower cost than present nozzles, without sacrificing reliability or performance.

In one embodiment of the present invention an adjustable flow nozzle assembly has a generally hollow shutoff body comprising a unitary member. The shutoff body further includes an inlet portion, an outlet portion, a shutoff body portion, a nozzle body adapter portion, and a nozzle body portion.

In another embodiment of the present invention a fixed flow nozzle assembly has a generally hollow shutoff body comprising a unitary member. The shutoff body further includes an inlet portion, an outlet portion, a shutoff body portion, a throat portion, and a nozzle body portion.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIGS. 1A and 1B are side and front elevational views respectively of a nozzle assembly according to an embodiment of the present invention;

FIGS. 2A, 2B and 2C are side, top and front views in section of the nozzle assembly of FIGS. 1A and 1B;

FIG. 3 is an expanded view showing an Allen screw fastener of the nozzle assembly of FIGS. 1A and 1B;

FIG. 4 shows a package containing supporting data for the nozzle assembly of FIGS. 1A and 1B;

FIG. 5 is an exploded view of the nozzle assembly of FIGS. 1A and 1B;

FIGS. 6A, 6B and 6C are exploded views of adapters for use with the nozzle assembly of FIGS. 1A and 1B according to various embodiments of the present invention;

FIGS. 7A, 7B and 7C are views in section of the adapters of FIGS. 6A, 6B and 6C respectively;

FIGS. 8A and 8B are side and rear elevational views respectively of a nozzle assembly according to another embodiment of the present invention;

FIGS. 9A and 9B are side and top views in section of the nozzle assembly of FIGS. 8A and 8B;

FIGS. 10 and 11 are expanded views showing a label and an Allen screw fastener, respectively, of the nozzle assembly of FIGS. 8A and 8B;

FIG. 12 shows a package containing supporting data for the nozzle assembly of FIGS. 8A and 8B;

FIG. 13 is an exploded view of the nozzle assembly of FIGS. 8A and 8B;

FIGS. 14A, 14B and 14C are exploded views of adapters for use with the nozzle assembly of FIGS. 8A and 8B according to various embodiments of the present invention;

and

FIGS. 15A, 15B and 15C are views in section of the adapters of FIGS. 14A, 14B and 14C respectively.

### DETAILED DESCRIPTION

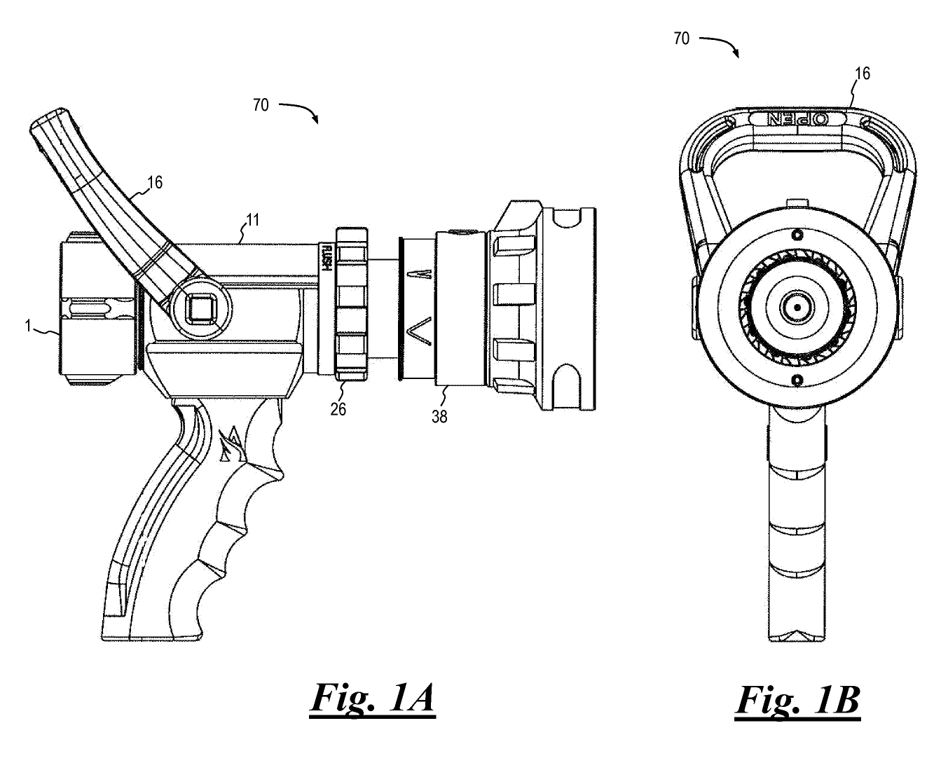

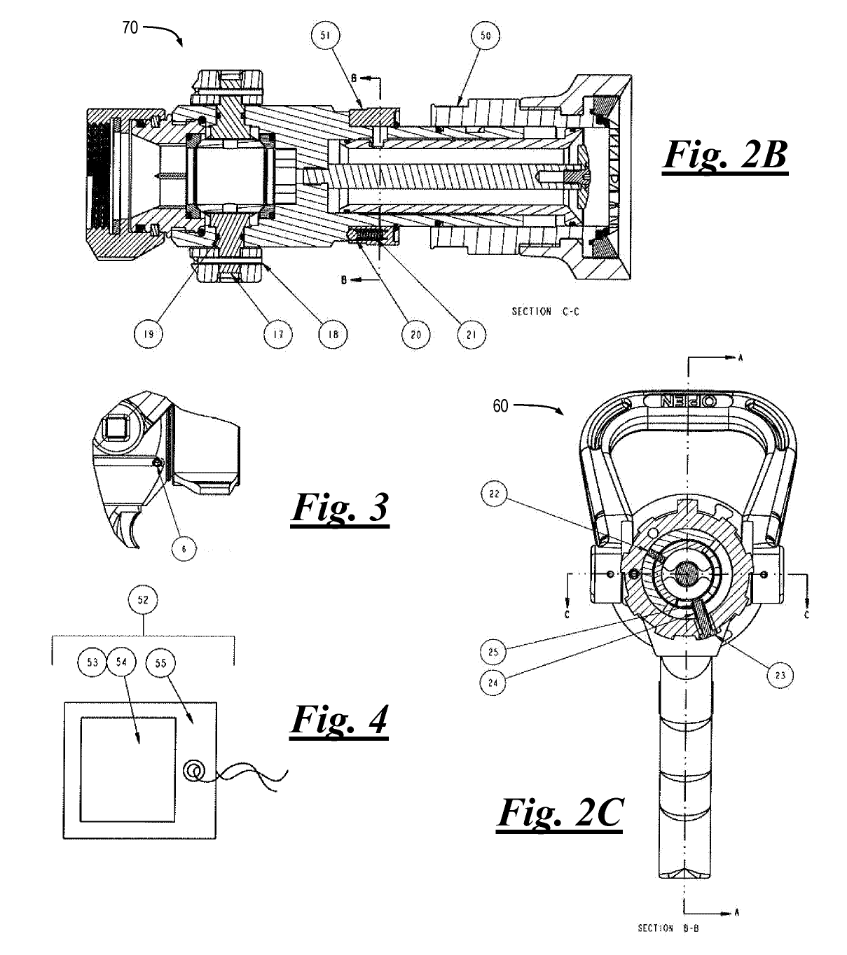

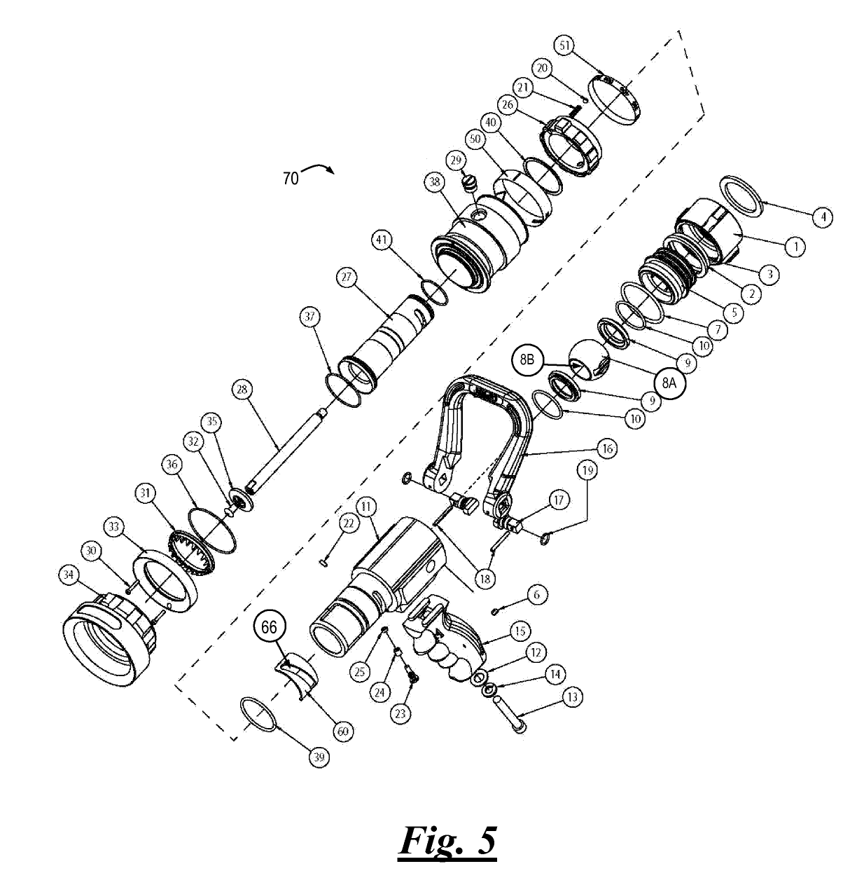

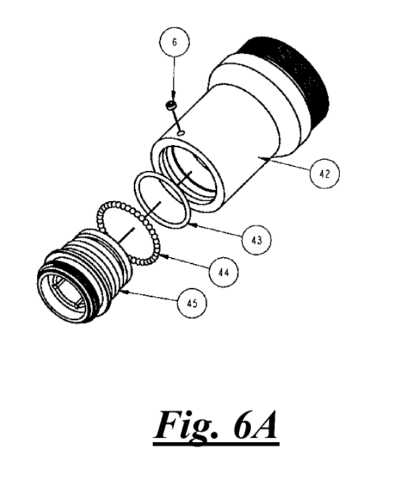

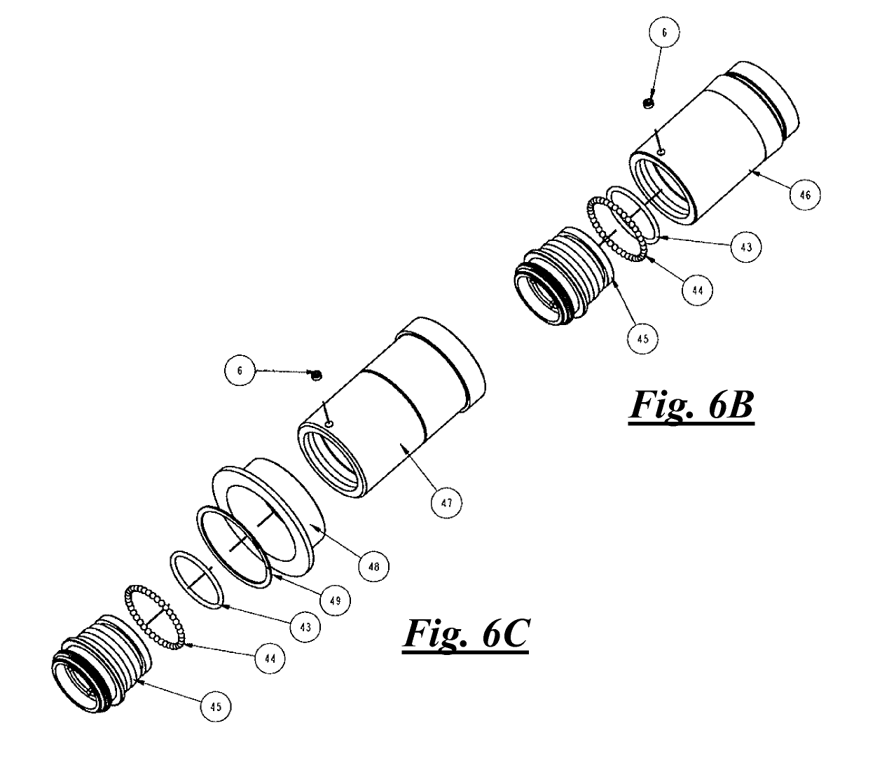

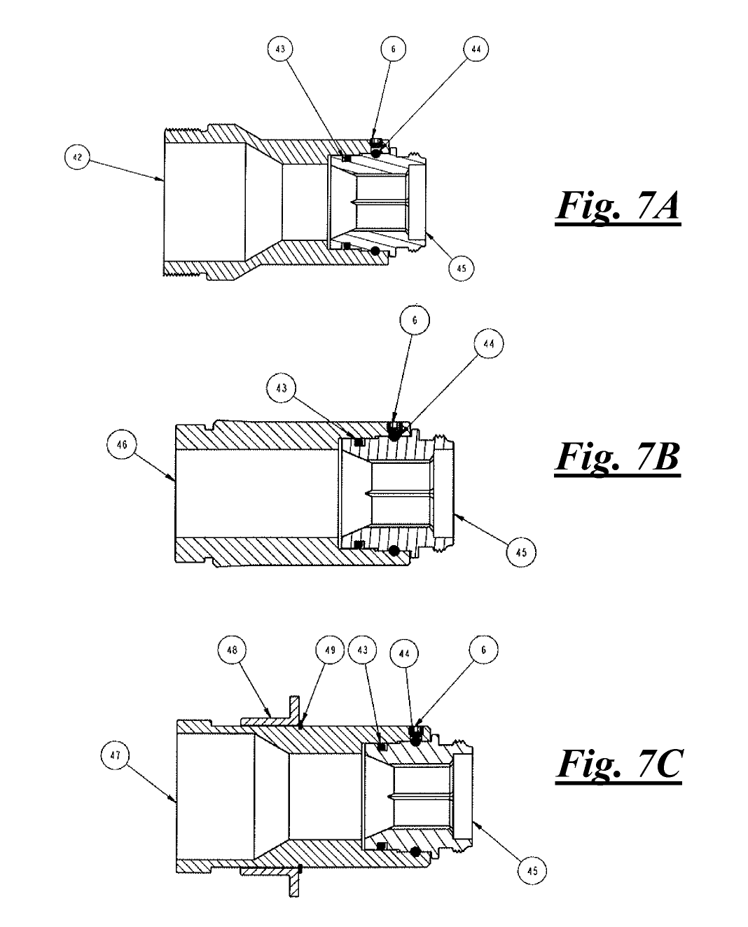

The general arrangement of a nozzle assembly 70 is shown in FIGS. 1A through 7C according to an embodiment of the present invention. The nozzle assembly 70 shown therein is an adjustable-flow type.

A shutoff handle 16 is pivotably coupled to a unitary shutoff body 11. Shutoff handle 16 is further coupled to a flow-controlling ball 8 by a pair of trunnions 17 such that pivoting the shutoff handle causes the ball to move rotatably in an inlet portion 62 of unitary shutoff body 11. Ball 8 is generally solid and has a bore disposed therethrough, forming ports at opposing ends of a closed wall. In operation, moving handle 16 such that the bore of the ball is generally aligned with inlet 62 allows pressurized fluid supplied to a swivel 1 of nozzle assembly 70 to flow through the inlet and an outlet 64 of the unitary shutoff body 11, exiting the nozzle assembly. Moving handle 16 such that the bore of ball 8 is less aligned with inlet portion 62 (i.e., at an angle to the inlet portion) reduces the flow of fluid through nozzle assembly 70. Nozzle assembly 70 is in an “Off” condition with essentially no fluid flowing therethrough when the bore of ball 8 is rotated forward and completely out of alignment with inlet portion 62, thus leaving only the closed wall of the ball to confront fluid entering the inlet portion.

The spray pattern of fluids discharged from nozzle assembly 70 is selectably set by rotatably adjusting a pattern sleeve 38 with respect to unitary shutoff body 11. The pattern of fluid emitted from outlet portion 64 of nozzle assembly 70 is adjustable from a narrowly-focused stream to a widely-focused “fog.”

In one embodiment of the present invention a cam insert 60 may be coupled to unitary shutoff body 11. Cam insert 60 is preferably made from a durable material, such as steel, to deter wear in a cam slot 66 of the insert due to movement of a cam screw 29 in the cam slot when rotating pattern sleeve 38 to adjust the pattern of fluid exiting outlet portion 64 of the nozzle assembly 70.

The flow rate of fluids through nozzle assembly 70 is variable and is adjusted by varying the position of a control ring 26. Actuating control ring 26 varies the position of a discharge tube 27 with respect to a baffle head 35, thereby controlling the size of an aperture delimited by the discharge tube and the baffle head. Increasing the size of the aperture increases the rate of fluid flow through nozzle assembly 70, while decreasing the size of the aperture decreases the rate of fluid flow through the nozzle assembly.

Table 1, below, is a parts list of an exemplary nozzle assembly 70. It will be understood that the various components listed in Table 1 are for reference only and may be substituted with similar components within the scope of the invention.

TABLE 1

| REF. # | NOMENCLATURE |
|---|---|
| 1 | SWIVEL |
| 2 | PISTON RING |
| 3 | O-RING |
| 4 | SWIVEL GASKET |
| 5 | SWIVEL ADAPTER |
| 6 | ALLEN HEAD SCREW |
| 7 | O-RING |
| 8A | BALL |
| 8B | BORE, BALL |
| 9 | SEAT |
| 10 | O-RING |
| 11 | UNITARY SHUTOFF BODY |
| 11A | SHUTOFF BODY PORTION |
| 11B | NOZZLE BODY ADAPTER PORTION |
| 11C | NOZZLE BODY PORTION |
| 12 | FLATWASHER |
| 13 | SOCKET HEAD SCREW |
| 14 | LOCK WASHER |
| 15 | PISTOL GRIP |
| 16 | SHUTOFF HANDLE |
| 17 | TRUNNION |
| 18 | ROLL PIN |
| 19 | O-RING |
| 20 | BALL |
| 21 | DETENT SPRING |
| 22 | DISCHARGE KEY |
| 23 | CAMAXLE |
| 24 | UPPER ROLLER CAM |
| 25 | LOWER ROLLER CAM |
| 26 | GALLONAGE CONTROL RING |
| 27 | DISCHARGE TUBE |
| 28 | BAFFLE STEM |
| 29 | PATTERN SLEEVE CAM SCREW |
| 30 | SOCKET HEAD SCREW |
| 31 | TURBINE |
| 32 | SOCKET HEAD SCREW |
| 33 | TURBINE RETAINING RING |
| 34 | BUMPER |
| 35 | BAFFLE HEAD |
| 36 | O-RING |
| 37 | O-RING |
| 38 | PATTERN SLEEVE |
| 39 | O-RING |
| 40 | RETAINING RING |
| 41 | O-RING |
| 42 | MALE ADAPTER |
| 43 | O-RING |
| 44 | BRASS BALL |
| 45 | STORZ ADAPTER SHUTOFF BODY |
| 46 | MALE ADAPTER |
| 47 | J.I.M. ADAPTER |
| 48 | PUSH RING |
| 49 | RETAINING RING |
| 50 | PATTERN SLEEVE BAND |
| 51 | DISCHARGE CONTROL RING BAND |
| 52 | PKG. PARTS LIST |
| 53 | INSTRUCTIONS |
| 54 | SHEET PARTS LIST |
| 55 | BAG |
| 56 | NOZZLE CONTAINER |
| 57 | ADAPTER CONTAINER |
| 60 | CAM INSERT |
| 62 | INLET PORTION, SHUTOFF BODY |
| 64 | OUTLET PORTION, SHUTOFF BODY |
| 66 | CAM SLOT, CAM INSERT |

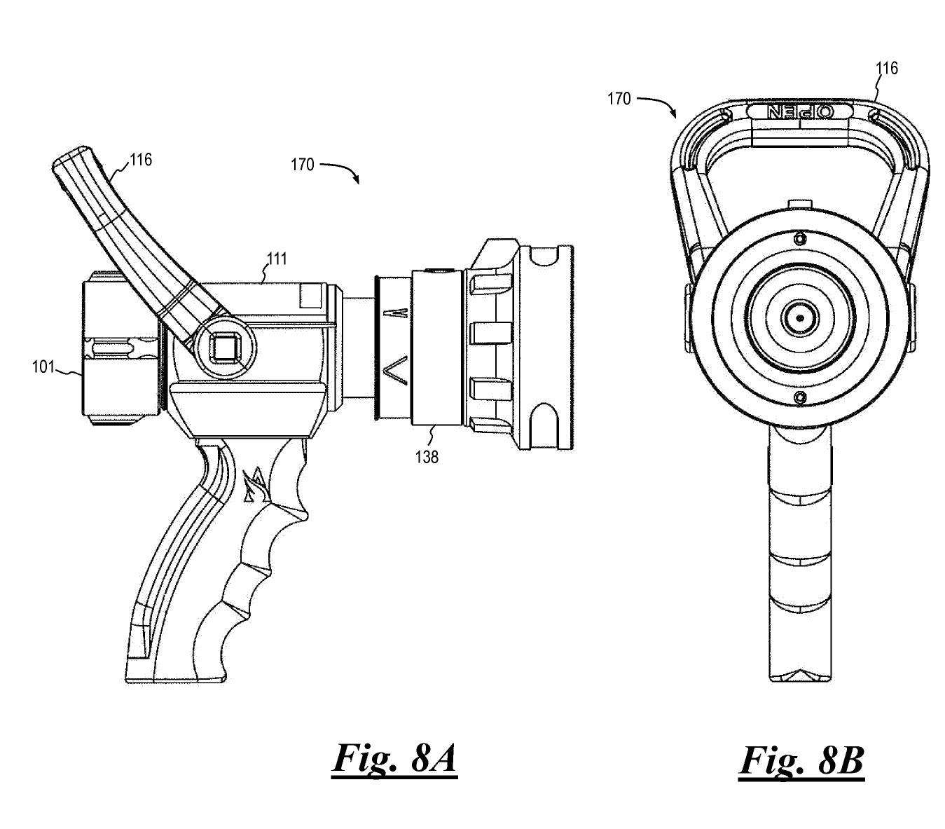

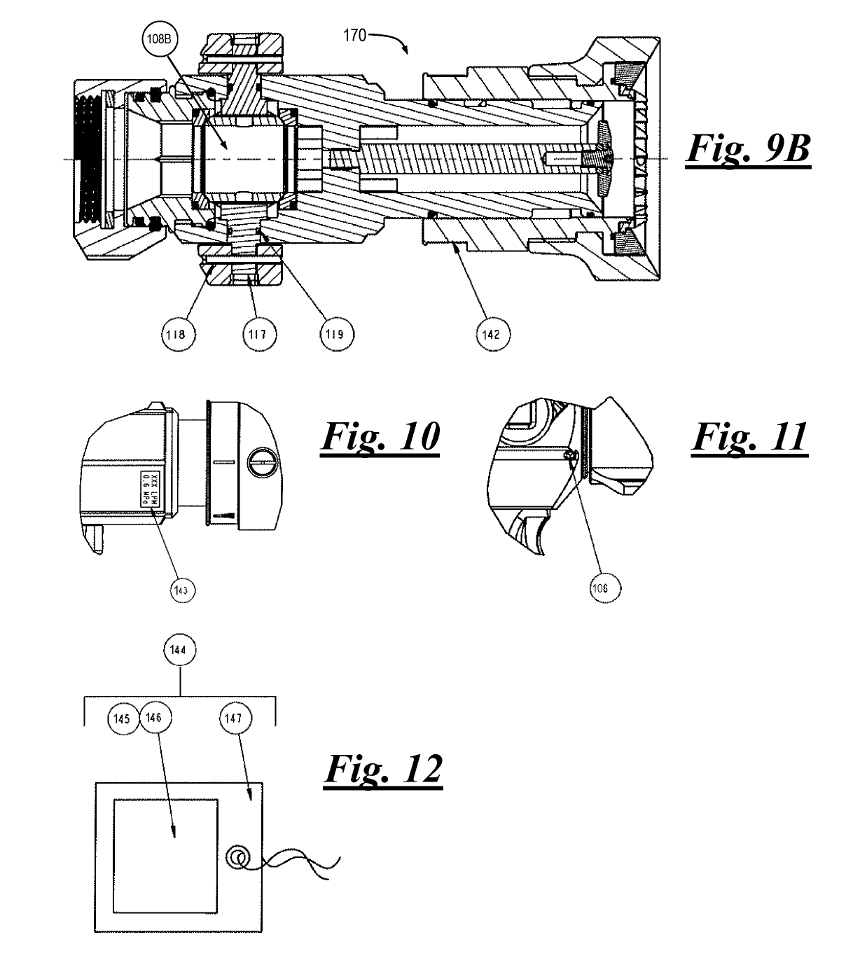

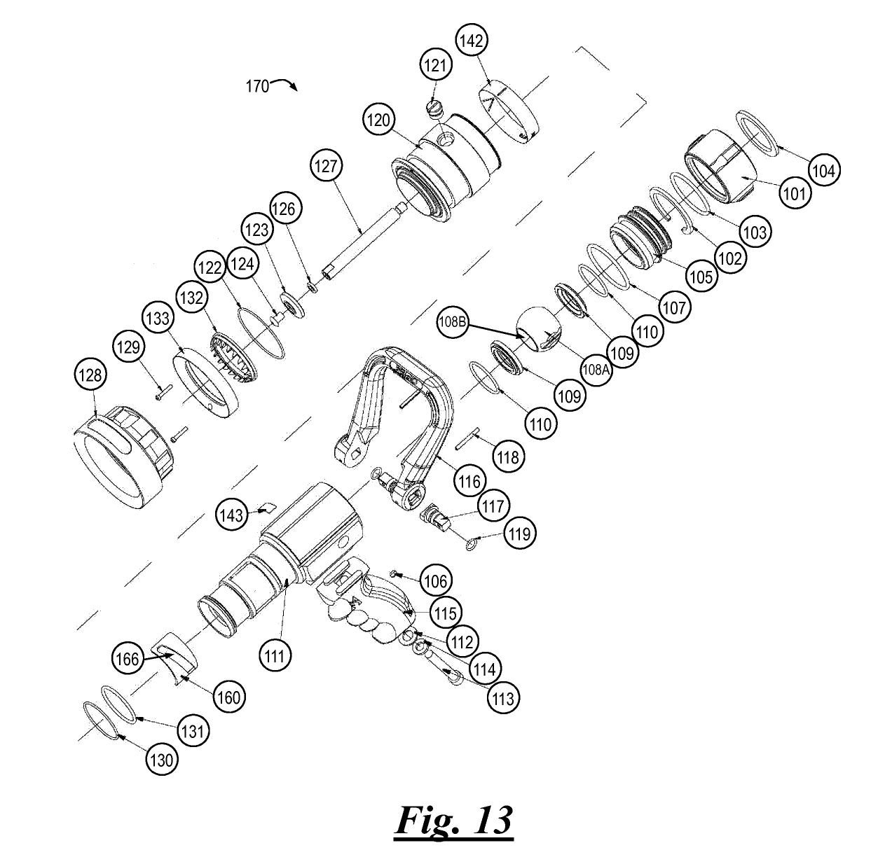

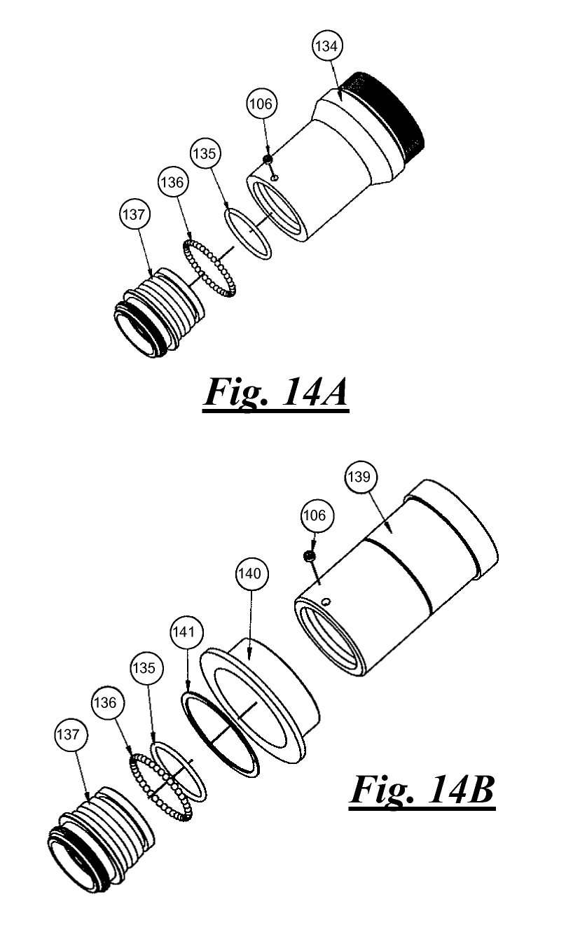

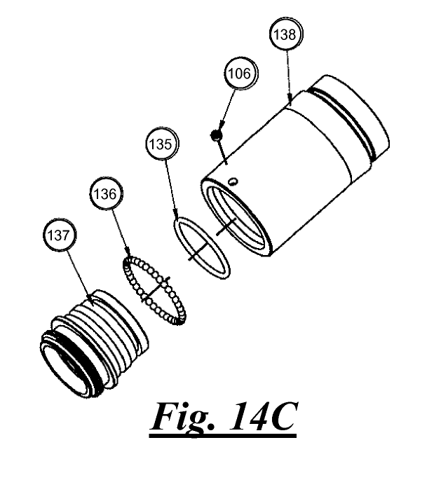

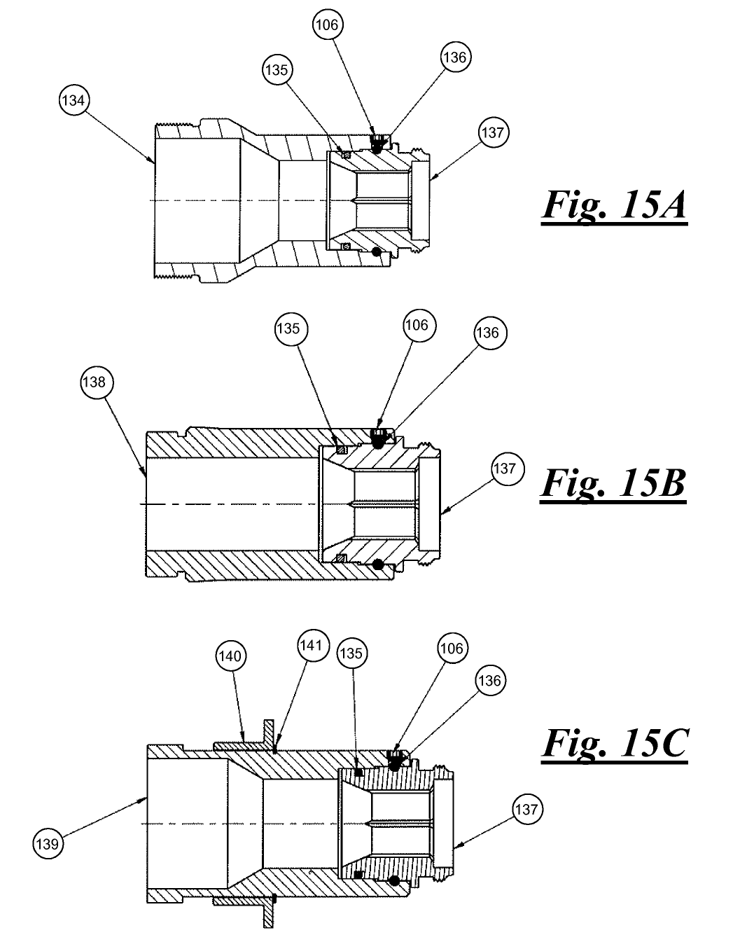

The general arrangement of a nozzle assembly 170 is shown in FIGS. 8A through 15C according to another embodiment of the present invention. The nozzle assembly shown therein is a fixed-flow type.

A shutoff handle 116 is pivotably coupled to a unitary shutoff body 111. Shutoff handle 116 is further coupled to a flow-controlling ball 108 by a pair of trunnions 117 such that pivoting the shutoff handle causes the ball to move rotatably in an inlet portion 162 of unitary shutoff body 111. Ball 108 is generally solid and has a bore disposed therethrough, forming ports at opposing ends of a closed wall. In operation, moving handle 116 such that the bore of the ball is generally aligned with inlet 162 allows pressurized fluid supplied to a swivel 101 of nozzle assembly 170 to flow through the inlet and an outlet 164 of the unitary shutoff body 111, exiting the nozzle assembly. Moving handle 116 such that the bore of ball 108 is less aligned with inlet portion 162 (i.e., at an angle to the inlet portion) reduces the flow of fluid through nozzle assembly 170. Nozzle assembly 170 is in an “Off” condition with essentially no fluid flowing therethrough when the bore of ball 108 is rotated forward and completely out of alignment with inlet portion 162, thus leaving only the closed wall of the ball to confront fluid entering the inlet portion.

The spray pattern of fluids discharged from nozzle assembly 170 is selectably set by rotatably adjusting a pattern sleeve 120 with respect to unitary shutoff body 111. The pattern of fluid emitted from outlet portion 164 of nozzle assembly 170 is adjustable from a narrowly-focused stream to a widely-focused “fog.”

In one embodiment of the present invention a cam insert 160 may be coupled to unitary shutoff body 111. Cam insert 160 is preferably made from a durable material, such as stainless steel, to deter wear in a cam slot 166 of the insert due to movement of a cam screw 121 in the cam slot when rotating pattern sleeve 120 to adjust the pattern of fluid exiting outlet portion 164 of the nozzle assembly 170.

The flow rate of fluids through nozzle assembly 170 is fixed by the size of an aperture delimited by a baffle head 123 and outlet portion 164. The size of the aperture may be increased, thus increasing the flow of fluid through nozzle assembly 170, by increasing the overall thickness of spacer 126 between baffle head 123 and a baffle stem 127. Conversely, size of the aperture may be decreased, thus decreasing the flow of fluid through nozzle assembly 170, by reducing the overall thickness of spacer 126 between baffle head 123 and a baffle stem 127.

Table 2, below, is a parts list of an exemplary nozzle assembly 170. It will be understood that the various components listed in Table 2 are for reference only and may be substituted with similar components within the scope of the invention.

TABLE 2

| REF. # | NOMENCLATURE |
|---|---|
| 101 | SWIVEL |
| 102 | PISTON RING |
| 103 | O-RING |
| 104 | SWIVEL GASKET |
| 105 | SWIVEL ADAPTER |
| 106 | ALLEN HEAD SCREW |
| 107 | O-RING |
| 108A | BALL |
| 108B | BORE, BALL |
| 109 | SEAT |
| 110 | O-RING |
| 111 | UNITARY SHUTOFF BODY |
| 111A | SHUTOFF BODY PORTION |
| 111B | THROAT PORTION |
| 111C | NOZZLE BODY PORTION |
| 112 | FLATWASHER |
| 113 | SOCKET HEAD SCREW |
| 114 | LOCK WASHER |
| 115 | PISTOL GRIP |
| 116 | SHUTOFF HANDLE |
| 117 | TRUNNION |
| 118 | ROLL PIN |
| 119 | O-RING |
| 120 | PATTERN SLEEVE |
| 121 | PATTERN SLEEVE CAM SCREW |
| 122 | O-RING |
| 123 | BAFFLE HEAD |
| 124 | SOCKET HEAD SCREW |
| 125 | TURBINE RETAINER |
| 126 | SPACER |
| 127 | BAFFLE STEM |
| 128 | BUMPER |
| 129 | SOCKET HEAD SCREW |
| 130 | O-RING |
| 131 | O-RING |
| 132 | TURBINE |
| 133 | TURBINE RETAINING RING |
| 134 | MALE ADAPTER |
| 135 | O-RING |
| 136 | BRASS BALL |
| 137 | STORZ ADAPTER SHUTOFF BODY |
| 138 | MALE ADAPTER |
| 139 | J.I.M. ADAPTER |
| 140 | PUSH RING |
| 141 | RETAINING RING |
| 142 | PATTERN SLEEVE BAND |
| 143 | LABEL |
| 144 | PKG. PARTS LIST |
| 145 | INSTRUCTIONS |
| 146 | SHEET PARTS LIST |
| 147 | BAG |
| 148 | NOZZLE CONTAINER |
| 149 | ADAPTER CONTAINER |
| 160 | CAM INSERT |
| 162 | INLET PORTION, SHUTOFF BODY |
| 164 | OUTLET PORTION, SHUTOFF BODY |
| 166 | CAM SLOT, CAM INSERT |

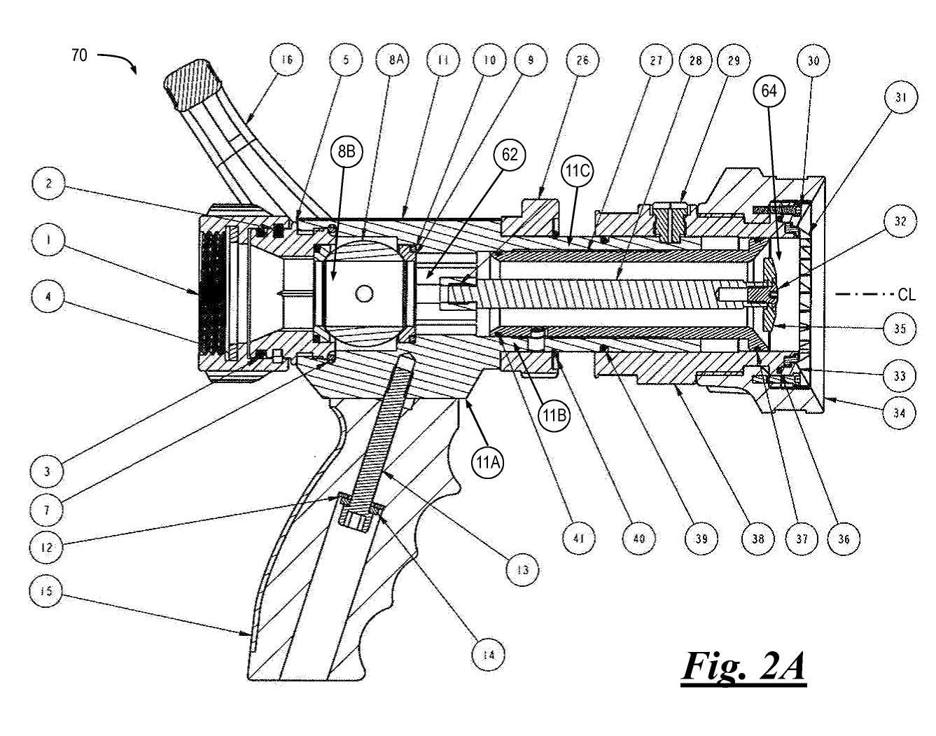

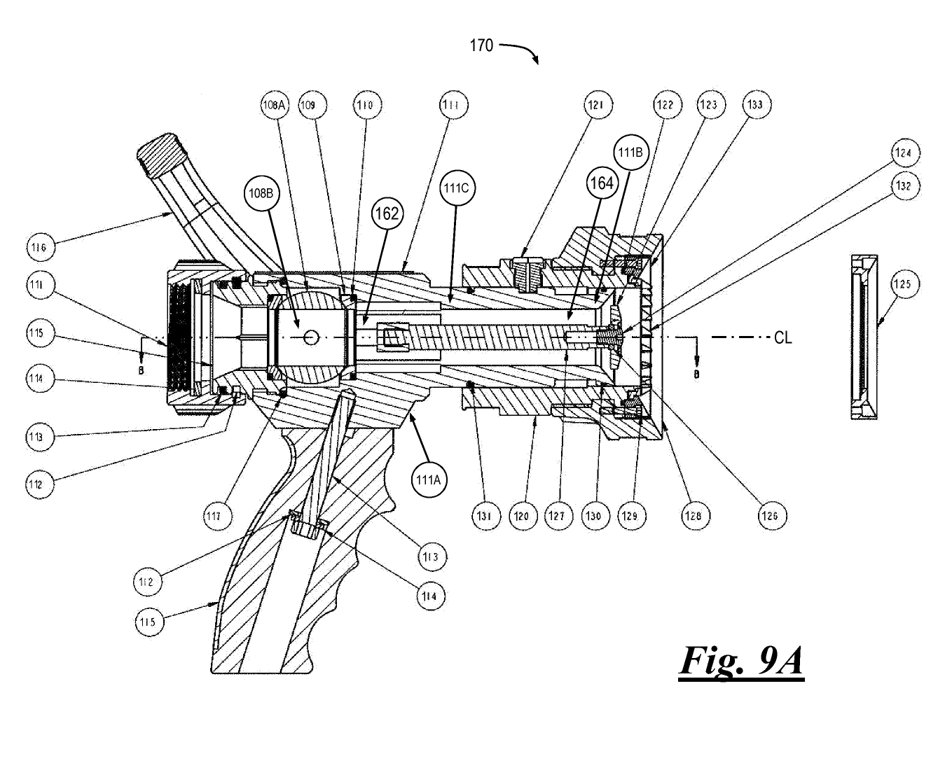

Unitary shutoff body 11, 111 reduces the cost and labor associated with production, assembly and repair as compared with nozzle assemblies having a plurality of shutoff body components. With reference to FIG. 2A, unitary shutoff body 11 comprises a shutoff body portion 11A, a nozzle body adapter portion 11B and a nozzle body portion 11C. In the past these portions have been discrete nozzle components, such as found in the Series 1700 TURBOJET adjustable flow nozzle available from Akron Brass Company of Wooster, Ohio. Similarly, with reference to FIG. 9A, unitary shutoff body 111 comprises a shutoff body portion 111A, a throat portion 111B and a nozzle body portion 111C. In the past these portions have been discrete nozzle components, such as found in the Series 4800 ASSAULT fixed-flow nozzle available from Akron Brass Company. Unitary shutoff body 11, 111 may be cast, molded or machined from a solid billet of material. Suitable materials include, without limitation, metals such as steel and aluminum, composites, and plastics.

In addition, the features of inlet portion 62, 162 are preferably machined or otherwise formed with a single tooling or machining set-up. Likewise, the features of outlet portion 64, 164 are preferably machined or otherwise formed with a single tooling or machining set-up. An advantage of a unitary shutoff body 11, 111 and machining inlet portions 62, 162 and outlet portions 64, 164 in this manner is improved tolerances of the machined features of the inlet and outlet portion with respect to a centerline “CL” of nozzle 70, 170, resulting in a fluid spray pattern discharge from the nozzle assembly having high uniformity using a fixed baffle. In contrast, prior nozzle assemblies typically include shutoff bodies comprising plural components and a number of machining set-ups, introducing small but cumulative errors in the locations of the features of the shutoff body. If off by even the slightest degree, the spray pattern discharged from the nozzle can be non-uniform, an undesirable characteristic and generally required the use of a more complex, “floating” baffle assembly.

It should be further noted that other components of the nozzles of the present invention may be consolidated in order to reduce the cost of the nozzles, within the scope of the invention. As a non-limiting example, swivel 1, 101 and swivel adapter 5, 105 may be made as a single piece having a swivel portion and an adapter portion. In addition, nozzle assemblies 70, 170 may utilize either a fixed baffle assembly or a floating baffle assembly.

While this invention has been shown and described with respect to a detailed embodiment thereof, it will be understood by those skilled in the art that changes in form and detail thereof may be made without departing from the scope of the claims of the invention.

What is claimed is:

1. A nozzle assembly comprising:
a generally hollow shutoff body comprising a unitary member, the shutoff body further including:
an inlet portion;
an outlet portion;
a shutoff body portion;
a nozzle body adapter portion; and
a nozzle body portion.

2. The nozzle assembly of claim 1, further comprising a shutoff handle pivotally coupled to the shutoff body

3. The nozzle assembly of claim 1, further comprising a generally solid ball disposed in the inlet portion of the shutoff body, the ball having a bore therethrough forming inlet and outlet ports at opposing ends of a closed wall, the ball being rotatable by pivoting the shutoff handle, the ball being configured for controlling the flow of fluid through the shutoff body, the amount of fluid flowing through the inlet and outlet portions of the shutoff body being variably controlled by the orientation of the bore of the ball with respect to the inlet portion.

4. The nozzle assembly of claim 1, further including a grip extending from the shutoff body.

5. The nozzle assembly of claim 1, further including a pattern sleeve rotatably coupled to the shutoff body, the pattern of fluid exiting the outlet portion being established by the rotational position of the pattern sleeve with respect to the shutoff body.

6. The nozzle assembly of claim 5, further including:
a cam insert coupled to the shutoff body, the cam insert having a cam slot; and
a cam screw coupled to the pattern sleeve, the cam screw engaging the cam slot,
the pattern sleeve being axially movable along the shutoff body by rotating the pattern sleeve with respect to the shutoff body.

7. The nozzle assembly of claim 1, further including:
a control ring rotatably coupled to the shutoff body;
a discharge tube disposed within the shutoff body and coupled to the control ring, the discharge tube being axially movable along the outlet portion by rotating the control ring;
a baffle head proximate a distal end of the discharge tube; and
an aperture delimited by the discharge tube and the baffle head, the size of the aperture being controlled by rotation of the control ring to adjust the axial position of the discharge tube with respect to the baffle head, the flow of fluid through the nozzle assembly being limited by the size of the aperture.

8. A nozzle assembly comprising:
a generally hollow shutoff body comprising a unitary member, the shutoff body further including:
an inlet portion;
an outlet portion;
a shutoff body portion;
a throat portion; and
a nozzle body portion.

9. The nozzle assembly of claim 8, further comprising a shutoff handle pivotally coupled to the shutoff body

10. The nozzle assembly of claim 8, further comprising a generally solid ball disposed in the inlet portion of the shutoff body, the ball having a bore therethrough forming inlet and outlet ports at opposing ends of a closed wall, the ball being rotatable by pivoting the shutoff handle, the ball being configured for controlling the flow of fluid through the shutoff body, the amount of fluid flowing through the inlet and outlet portions of the shutoff body being variably controlled by the orientation of the bore of the ball with respect to the inlet portion.

11. The nozzle assembly of claim 8, further including a grip extending from the shutoff body.

12. The nozzle assembly of claim 8, further including a pattern sleeve rotatably coupled to the shutoff body, the pattern of fluid exiting the outlet portion being established by the rotational position of the pattern sleeve with respect to the shutoff body.

13. The nozzle assembly of claim 12, further including:
a cam insert coupled to the shutoff body, the cam insert having a cam slot; and
a cam screw coupled to the pattern sleeve, the cam screw engaging the cam slot,
the pattern sleeve being axially movable along the shutoff body by rotating the pattern sleeve with respect to the shutoff body.
